(19) United States
(12) Patent Application Publication
(10) Pub. No.: US 2015/0138324 A1
(43) Pub. Date: May 21, 2015

(54) APPARATUS FOR DETECTING VEHICLE LIGHT AND METHOD THEREOF

(71) Applicant: DENSO CORPORATION, Kariya-city, Aichi-pref. (JP)

(72) Inventor: Noriaki Shirai, Chiryu-shi (JP)

(73) Assignee: DENSO CORPORATION, Kariya-city, Aichi-pref. (JP)

(21) Appl. No.: 14/401,273

(22) PCT Filed: May 16, 2013
(86) PCT No.: PCT/JP2013/063620

§ 371 Date: Nov. 14, 2014

(30) Foreign Application Priority Data
May 16, 2012 (JP) 2012-112473

(51) Int. Cl. G06K 9/00; H04N 13/02

(52) U.S. Cl. CPC G06K 9/00825; H04N 13/0239; H04N 13/0296
USPC 348/47

(57) ABSTRACT

In an image analysis apparatus, by control of a stereo camera, left and right cameras capture images of a common area ahead of an own vehicle, and generate pieces of image data (left and right image data) expressing the captured images. At this time, exposure timings of the left camera and the right camera are controlled so that the exposure timing of the left camera is shifted from that of the right camera. Pieces of image data (left and right image data) having differing exposure timings are obtained. Based on either piece of image data, candidates for vehicle light are extracted. Furthermore, a flashing light is detected by the left image data and the right image data being compared. The detected flashing light is eliminated from the extracted candidates for vehicle light. A light source that ultimately remains as the candidate for vehicle light is detected as the vehicle light.

### CROSS REFERENCE TO RELATED APPLICATION

This application is a U.S. National Phase application under 35 U.S.C. 371 of International Application No. PCT/JP2013/063620 filed on May 16, 2013 and published in Japanese as WO 2013/172398 A1 on Nov. 21, 2013. This application is based on and claims the benefit of priority from Japanese Patent Application No. 2012-112473 filed May 16, 2012. The entire disclosures of all of the above applications are incorporated herein by reference.

### BACKGROUND

1. Technical Field

The present invention relates to an apparatus for detecting vehicle light and a method thereof. In particular, the present invention relates to an apparatus for detecting light from another vehicle that is present near the vehicle using an imaging means, and a method thereof.

2. Background Art

Conventionally, a system is known that detects light from a vehicle and performs light distribution control of headlights (refer to, for example, PTL 1). In this system, for example, camera images are sampled at high speed. The frequency of a light source captured in the camera images is calculated. Lights, such as streetlights (lights that become noise), are eliminated from candidates for vehicle light based on the calculated frequency of the light source.

[PTL 1] JP-A-2008-211410

### Technical Problem

Light sources that may possibly be captured by an on-board camera include traffic lights and the like, in addition to vehicle lights and streetlights. As a traffic light, an LED traffic light is known that flashes with a frequency of about 100 to 120 Hz (hertz).

Therefore, to eliminate light other than light from another vehicle, or in other words, light that becomes noise, from the lights captured by the on-board camera using conventional technology, an expensive camera capable of high-speed sampling is required to be mounted in the vehicle. However, when such a method is used, the manufacturing cost of the system becomes high.

### SUMMARY

Hence it is desired to provide a technology enabling vehicle light to be accurately detected from camera images without use of an expensive camera that is capable of high-speed sampling.

An exemplary embodiment relates to a light detection apparatus that detects vehicle light. The light detection apparatus includes first and second imaging means, a control means, and a vehicle light detecting means. The first and second imaging means captures images of a common area ahead and generates pieces of image data expressing the captured images. The control means controls the exposure timings of the first and second imaging means so that the exposure timing of the second imaging means is shifted from that of the first imaging means, and acquires a pair of image data having differing exposure timings from the first and second imaging means. The vehicle light detecting means analyzes the pieces of image data obtained from the first and second imaging means by operation of the control means, and detects vehicle light that is captured in the pieces of image data.

Specifically, the vehicle light detecting means includes a flashing light detecting means and an eliminating means. By the flashing light detecting means, the vehicle light detecting means detects light that is captured in the pieces of image data and is flashing by comparing the image data obtained from the first imaging means and the image data obtained from the second imaging means. By the eliminating means, the vehicle light detecting means eliminates light detected by the flashing light detecting means from candidates for vehicle light.

According to the light detecting apparatus, light that is flashing is detected based on the pair of image data having differing exposure timings obtained using the first and second imaging means. Therefore, high-frequency flashing lights can be detected without use of an expensive camera capable of high-speed sampling as the imaging means. A flashing light which is not a vehicle light can be eliminated from the candidates for vehicle light. The vehicle light can be accurately detected. Therefore, a high-accuracy light detection apparatus can be manufactured at low cost.

The vehicle light detecting means can be configured to include a candidate detecting means for detecting light serving as a candidate for vehicle light captured in the image data, based on either of the pieces of image data obtained from the first and second imaging means by operation of the control means. In this instance, the eliminating means can eliminates the light that is flashing, detected by the flashing light detecting means, from the lights detected as the candidates for vehicle light by the candidate detecting means.

In addition, a vehicle controls system can be configured to include a headlight control means for switching an irradiation direction of beams from headlights of an own vehicle, based on the detection results for vehicle light from the above-described light detection apparatus. In the vehicle control system, appropriate headlight control can be performed based on highly accurate detection results for vehicle light.

### BRIEF DESCRIPTION OF DRAWINGS

In the accompanying drawings:

FIG. 1 is a block diagram of a configuration of a vehicle control system 1;

FIG. 2 is a time chart showing the aspects of exposure control in a stereo imaging mode and in a vehicle light detection mode;

FIG. 3 is a flowchart of a stereoscopic detection process performed by a control unit 15;

FIG. 4 is a flowchart of a vehicle light detection process performed by the control unit 15;

FIG. 5 is a flowchart of a flashing light source elimination process performed by the control unit 15;

FIG. 6 is a diagram for explaining the aspects of flashing light source detection;

FIG. 7 is a diagram for explaining the differences in luminance caused by changes in the intensity of incident light from the flashing light source; and

FIG. 8 is a flowchart of a headlight automatic control process performed by a vehicle control apparatus 20.

### DETAILED DESCRIPTION OF THE PREFERRED EMBODIMENTS

An embodiment of the present invention will hereinafter be described together with the drawings.

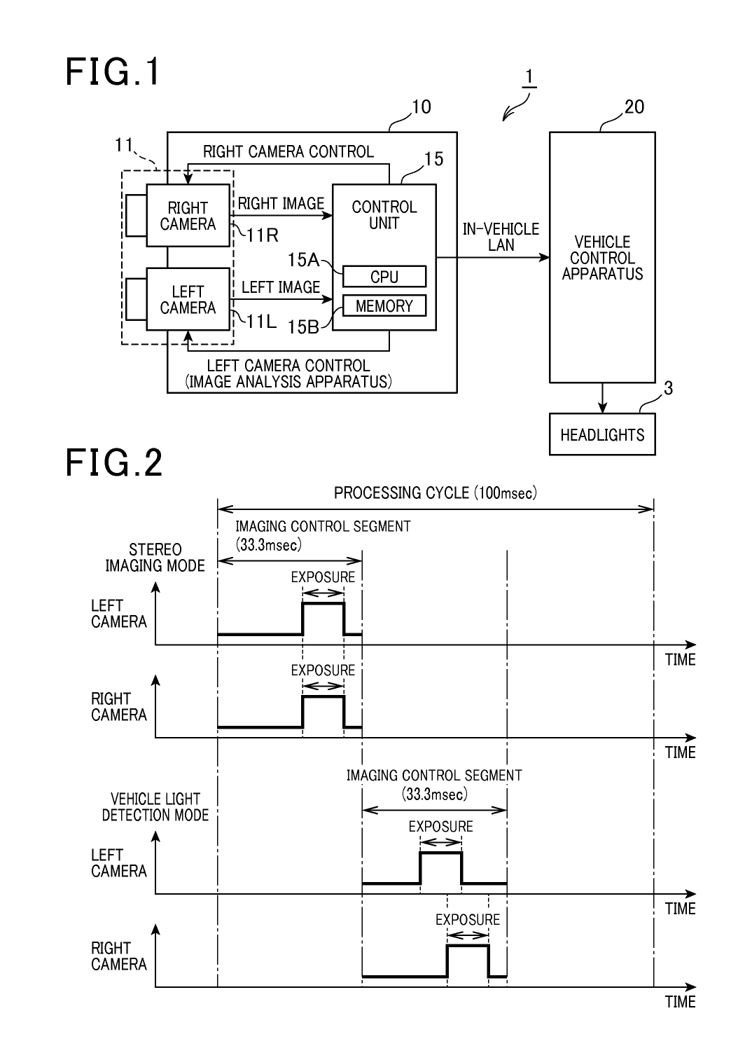

A vehicle control system 1 of the present embodiment is mounted in a vehicle (such as an automobile) that includes headlights 3. As shown in FIG. 1, the vehicle control system 1 includes an image analysis apparatus 10 and a vehicle control apparatus 20. The image analysis apparatus 10 captures an image of the area ahead of the own vehicle and analyzes image data expressing the captured image. The image analysis apparatus 10 thereby detects the state of the area ahead of the own vehicle. The image analysis apparatus 10 includes a stereo camera 11 and a control unit 15.

The stereo camera 11 includes a left camera 11L and a right camera 11R, in a manner similar to known stereo cameras. The left camera 11R and the right camera 11R each capture an image of an area ahead of the own vehicle that is common to the left camera 11R and the right camera 11R from differing positions (left and right of the own vehicle). The left camera 11L and the right camera 11R then input image data expressing the captured images to the control unit 15.

On the other hand, the control unit 15 performs integrated control of the image analysis apparatus 10. The control unit 15 includes a central processing unit (CPU) 15A, a memory 15B serving as a non-transitory computer readable medium, an input/output port (not shown), and the like. The CPU 15A performs various processes based on programs recorded in the memory 15B, thereby enabling the control unit 15 to perform integrated control of the image analysis apparatus 10.

By performing the processes based on the programs, the control unit 15 controls the exposure timings of the left camera 11L and the right camera 11R. The control unit 15 then analyzes the image data obtained from the left camera 11L and the right camera 11R based on the control. As a result of the image analysis, the control unit 15 detects the distance to an object present in the area ahead of the own vehicle and vehicle light present in the area ahead of the own as the state of the area ahead of the own vehicle. The control unit 15 then transmits the detection results to the vehicle control apparatus 20 over an in-vehicle local area network (LAN).

The vehicle control apparatus 20 receives the above-described detection results transmitted from the image analysis apparatus 10 via the in-vehicle LAN. The vehicle control apparatus 20 performs vehicle control based on the above-described detection results obtained through the reception. Specifically, as vehicle control, the vehicle control apparatus 20 performs vehicle control to avoid collision based on the distance to an object ahead. The vehicle control apparatus 20 also performs vehicle control to switch beam irradiation angles in the up/down direction from the headlights 3 based on the detection results regarding vehicle light.

In this way, the vehicle control system 1 of the present example detects the state of the area ahead of the own vehicle using the stereo camera 11 and performs vehicle control based on the detection results. The vehicle control system 1 also functions as a so-called auto high-beam system by performing the above-described switching operation of the beam irradiation angle.

Next, details of the image analysis apparatus 10 will be described. The control unit 15 included in the image analysis apparatus 10 repeatedly performs predetermined processes at each processing cycle. The control unit 15 thereby detects the distance to an object present in the area ahead of the own vehicle and detects vehicle light present in the area ahead of the own vehicle.

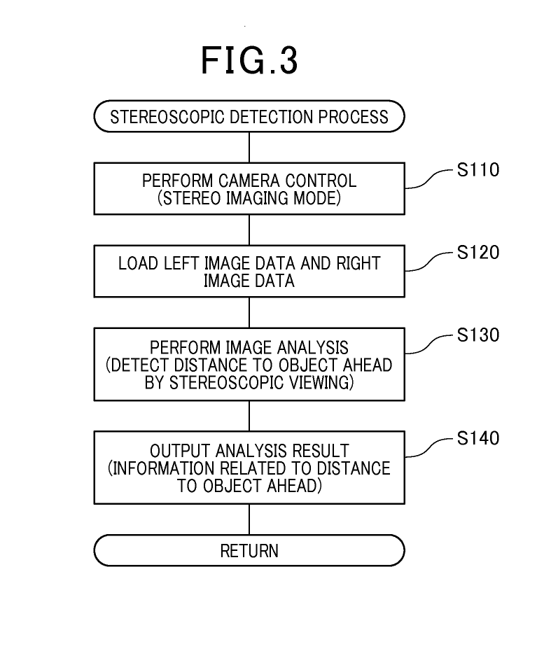

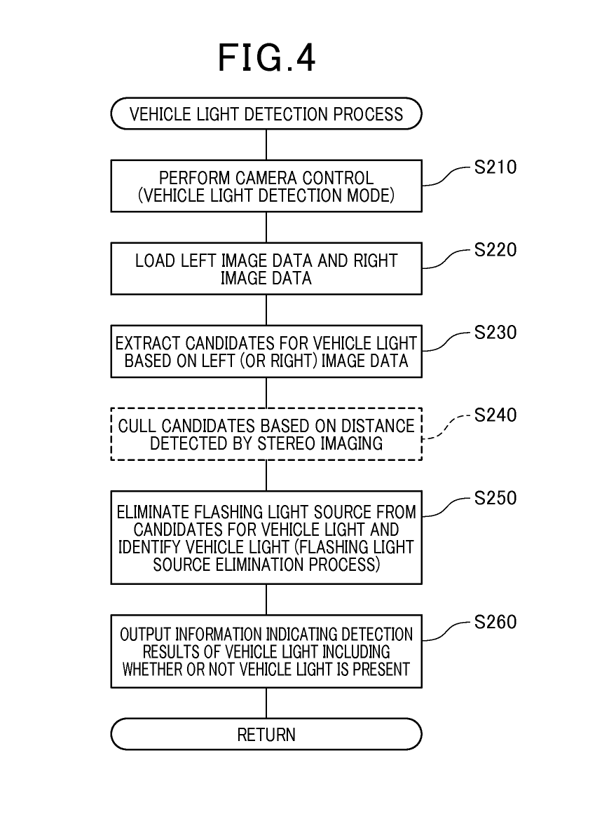

Specifically, at night when the auto high-beam system function is turned ON, the control unit 15 performs a stereoscopic detection process shown in FIG. 3 and a vehicle light detection process shown in FIG. 4 in parallel at each processing cycle. As shown in the upper rows in FIG. 2, in the stereoscopic detection process, the control unit 15 performs camera control in stereo imaging mode during a first imaging control segment that is the head segment of the processing cycle (Step S110). Stereo imaging mode is a control mode of the stereo camera 11. In stereo imaging mode, the exposure timings of the left camera 11L and the right camera 11R are controlled so that the exposure periods of the left camera 11L and the right camera 11R match. During the first imaging control segment, imaging of the area ahead of the own vehicle is performed by camera control such as this.

On the other hand, as shown in the lower rows in FIG. 2, in the vehicle light detection process, the control unit 15 performs camera control in vehicle light detection mode during a second imaging control segment that follows the first imaging control segment in the above-described processing cycle (S210). Vehicle light detection mode is a control mode of the stereo camera 11, in a manner similar to stereo imaging mode. In vehicle light detection mode, the exposure timings of the left camera 11L and the right camera 11R are controlled so that the exposure timing of the left camera 11L is shifted from that of the right camera 11R. During the second imaging control segment, imaging of the area ahead of the own vehicle is performed by camera control such as this.

According to the example shown in FIG. 2, the processing cycle is a cycle of 100 milliseconds. The first and second imaging control segments are each a cycle of about 33.3 milliseconds, which is one-third of the processing cycle. In addition, the exposure periods of the left camera 11L and the right camera 11R during the first and second imaging control segments are each about 8 milliseconds. The amount of shift in the exposure timings during the second imaging control segment is about 4 milliseconds.

Through the stereoscopic detection process performed by the control unit 15, the control unit 15 loads, from the left camera 11L and the right camera 11R, the pieces of image data respectively generated by the left camera 11L and the right camera 11R by exposure operations during the first imaging control segment (Step S120). The pieces of image data are loaded before exposure is started in the second imaging control segment. On the other hand, through the vehicle light detection process performed by the control unit 15, the control unit 15 loads, from the left camera 11L and the right camera 11R, the pieces of image data respectively generated by the left camera 11L and the right camera 11R by exposure during the second imaging control segment, after completion of the exposure operations of the left camera 11L and the right camera 11R (Step S220).

Next, details of the stereoscopic detection process repeatedly performed by the control unit 15 at each processing cycle will be described with reference to FIG. 3. When the stereoscopic detection process is started, the control unit 15 performs camera control in stereo imaging mode, described above. As shown in the upper rows in FIG. 2, during the first imaging control segment, the control unit 15 controls the exposure timings of the left camera 11L and the right camera 11R so that the exposure periods of the left camera 11L and the right camera 11R match (Step S110).

Then, after the end of the exposure period, the control unit 15 loads, from the left camera 11L and the right camera 11R, the pieces of image data expressing captured images of the area ahead of the own vehicle respectively generated by photoelectric effect during the exposure period by the left camera 11L and the right camera 11R (Step S120). Hereinafter, the image data loaded from the left camera 11L may also be referred to as left image data. The image data loaded from the right camera 11R may also be referred to as right image data.

Then, the control unit 15 performs a known image analysis process based on the loaded left image data and right image data, thereby stereoscopically viewing the area ahead of the vehicle. Here, the control unit 15 performs a process to determine the parallax of each object captured in both the left image data and the right image data, and calculates the distance to each object in the manner of triangulation based on the parallax (Step S130).

Subsequently, the control unit 15 transmits, to the vehicle control apparatus 20 over the in-vehicle LAN, information related to the distance to each object appearing in both the left image data and the right image data that has been calculated at Step S130 as information expressing the state ahead of the own vehicle (Step S140). The control unit 15 then ends the stereoscopic detection process. Information related to the distance to each light source, as the object appearing in both the left image data and the right image data, is also used to eliminate light sources unsuitable as candidates for vehicle light at Step S240.

Next, details of the vehicle light detection process repeatedly performed by the control unit 15 at each processing cycle will be described with reference to FIG. 4.

When the vehicle light detection process is started, the control unit 15 performs camera control in vehicle light detection mode. As shown in the lower rows in FIG. 2, the control unit 15 controls the exposure timings of the left camera 11L and the right camera 11R so that the exposure timing of the left camera 11L precedes that of the right camera 11R (Step S210). Camera control in vehicle light detection mode is that which shifts the exposure timings. However, the exposure time of each left camera 11L and right camera 11R is not changed. In other words, the exposure times of the left camera 11L and the right camera 11R are the same.

Then, after the end of the exposure period by the above-described camera control, the control unit 15 loads, from the left camera 11L and the right camera 11R, the pieces of image data expressing captured images of the area ahead of the own vehicle respectively generated by photoelectric effect during the exposure period by the left camera 11L and the right camera 11R (Step S220).

Subsequently, the control unit 15 performs a process to extract candidates for vehicle light using one of either the left image data obtained from the left camera 11L or the right image data obtained from the right camera 11R (Step S230). To simplify the description, an example is described hereafter in which the candidates for vehicle light are extracted from the left image data. However, it goes without saying that the right image data may be used instead of the left image data. At Step S230, the candidates for vehicle light can be extracted using a known technique for extracting candidates for vehicle light using a single-lens camera.

Based on a technique disclosed in JP-A-2008-67086, which is a known technique, a pixel area having luminance of a threshold or higher within the left image data is detected as a pixel area in which a light source is captured. A group of light sources are classified into a light source pair aligned in the horizontal direction, and an ordinary light source which is a single light source that does not form a pair. The light source pair and the ordinary light source are each set as candidates for vehicle light corresponding to a single vehicle. Then, based on the distance between the pair of light sources that are aligned in the horizontal direction or the width of the ordinary light source in the left image data, the distance to the vehicle when the light source is presumed to be a vehicle light is calculated for each vehicle corresponding to the light source. For example, the distance to the vehicle corresponding to the light source is calculated under a presumption that the distance between a pair of light sources or the width of an ordinary light source corresponds to the average distance (such as 1.6 m) between the left and right lights of a vehicle.

Furthermore, for each vehicle, a road ground position of the vehicle is calculated under a presumption that the distance between a pair of light sources that are aligned in the horizontal direction, or a predetermined proportion of the width of two points having high luminance in an ordinary light source or the width of an ordinary light source is the distance from a light attachment position on the vehicle to the road surface. On the other hand, for each vehicle, the road ground position of the vehicle is calculated based on the calculated distance to the vehicle and coordinates of the corresponding light source in the image data. Light sources of which the difference in these calculation values is greater than a reference value are eliminated from the candidates for vehicle light.

In this way, at Step S230, the control unit 15 extracts, as the candidates for vehicle light, the light sources captured in the left image data obtained from the left camera 11L, from which light sources that do not meet the characteristics of a vehicle light have been eliminated. However, in such extraction methods, when the disposition of a light source that is not a vehicle light is a disposition that is not inconsistent with a disposition when the light source is presumed to be a vehicle light, the light source cannot be eliminated from the candidates for vehicle light.

Therefore, at Step S240, the control unit 15 eliminates light sources that are unsuitable as the candidates for vehicle light from the group of light sources extracted as the candidates for vehicle light at Step S230, based on the distances to the light sources detected by the stereoscopic detection process. As a result, the control unit 15 culls the candidates for vehicle light using the results of the stereoscopic detection process. For example, at Step S240, regarding each light source extracted as a candidate for vehicle light at Step S230, the distance to the light source detected by the stereoscopic detection process is considered to be the distance to the vehicle. A light source that is eliminated from the candidates for vehicle light when a process similar to that at Step S230 is performed is considered to be the above-described unsuitable light source. Culling of the candidates for vehicle light is thereby performed.

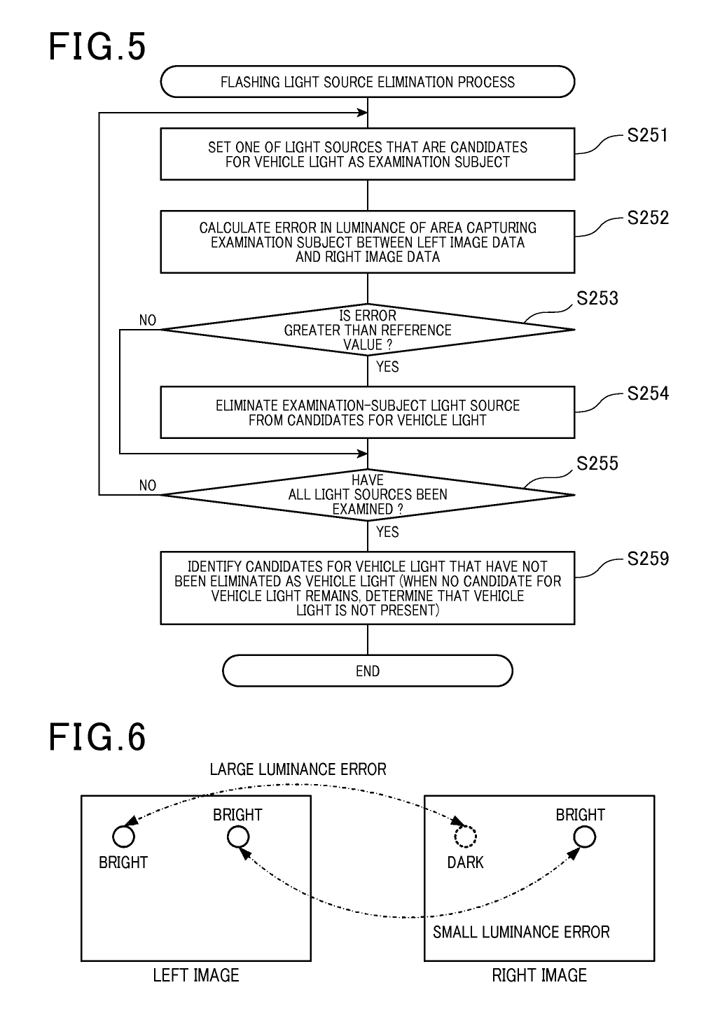

When the process is completed, the control unit 15 performs a flashing light source elimination process shown in FIG. 5, thereby further culling the candidates for vehicle light. As a result, the control unit 15 performs identification of the vehicle light (Step S250). Specifically, in the flashing light source elimination process, the control unit 15 selects one of the light sources that currently remain as the candidates for vehicle light as an examination subject (Step S251). The control unit 15 calculates an error between the luminance of the light source that has been selected as the examination subject in the left image data and the luminance of the light source that is the examination subject in the right image data (Step S252).

Then, the control unit 15 determines whether or not the calculated error is greater than a reference value (Step S253). When determined that the error is greater than the reference value (Yes at Step S253), the control unit 15 eliminates the examination-subject light source from the candidates for vehicle light (Step S254) and proceeds to Step S255. On the other hand, when determined that the calculated error is the reference value or less (No at Step S253), the control unit 15 proceeds to Step S255 with the examination-subject light source remaining as a candidate for vehicle light.

For example, when the luminance of the examination subject is high in both the left image data and the right image data, and the error in luminance is the reference value or less, the examination-subject light source is retained as a candidate for vehicle light. On the other hand, when the luminance of the examination subject is high in either the left image data or the right image data and low in the other, and therefore, the error in luminance is greater than the reference value, the examination-subject light source is eliminated from the candidates for vehicle light.

According to the flashing light source elimination process, in this way, a light source having a large luminance error is considered to be a flashing light source and is eliminated from the candidates for vehicle light. Here, the reason for which the probability is high that a light source having a large luminance error is not a vehicle light will be described in detail.

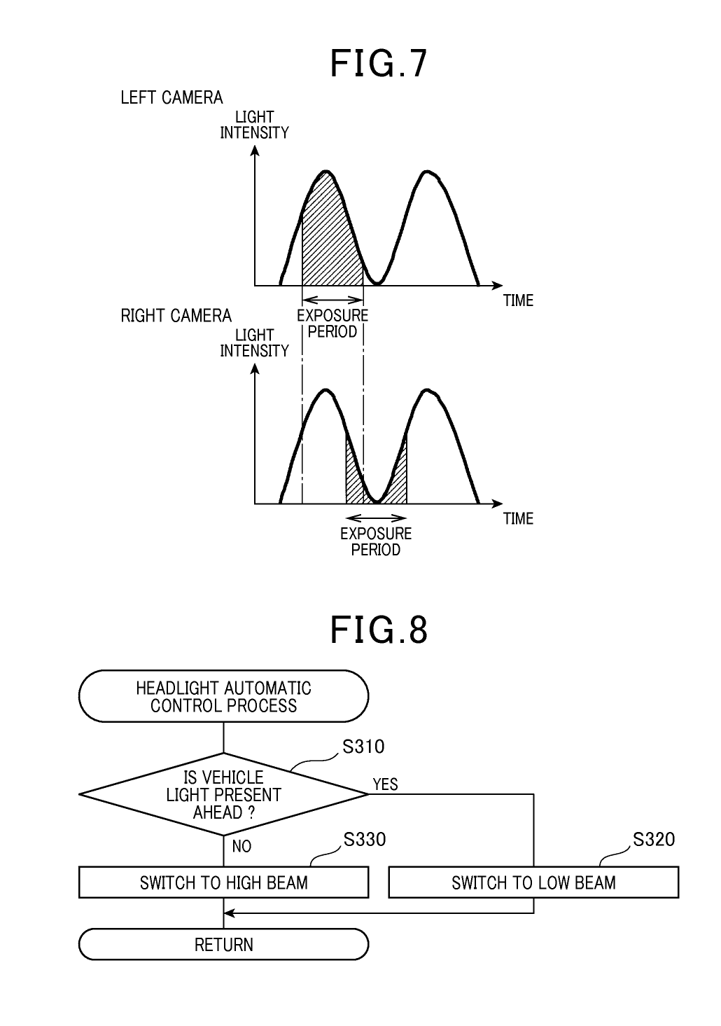

The left image data and the right image data used in the flashing light source elimination process are a pair of images data generated by camera control in vehicle light detection mode. In vehicle light detection mode, control is performed so that the exposure timings are shifted, as described above. When images of a flashing light source are captured by control such as that which shifts the exposure timings, as shown in FIG. 7, the changes in intensity of the incident light from the light source during the exposure period differ between the left camera 11L and the right camera 11R. Therefore, as indicated by the shading in FIG. 7, this results in a difference in luminance in the pixel area capturing the light source between the left image data and the right image data.

On the other hand, the intensity of incident light during the exposure period from a light source that is driven by a direct-current power source, such as a vehicle light, is fixed and does not change in the manner shown in FIG. 7. Therefore, error in luminance between the left image data and the right image data is minimal. Thus, the probability is high that a light source having a large luminance error is not a vehicle light. For such reasons, at Step S254, a light source having a large luminance error is eliminated from the candidates for vehicle light.

However, to detect the flashing light source based on the error in luminance between the left image data and the right image data, the amount of shift in the exposure timings and the exposure period are required to be adjusted to values suitable for the frequency band of the flashing light source. Therefore, the amount of shift in the exposure timings and the exposure period are determined by the designer based on tests and the like, taking into consideration the frequency of the flashing light source to be eliminated from the candidates for vehicle light.

After proceeding to Step S255, the control unit 15 determines whether or not the processes at Step S252 and subsequent steps have been performed for all light sources remaining as the candidates for vehicle light, with each remaining light source as the examination subject. When determined that not all light sources have been processed (No at Step S255), the control unit 15 proceeds to S251. The control unit 15 selects a new light source that has not yet been selected as the examination subject as the examination subject, and performs the processes at Step S252 and subsequent steps.

Then, when determined that the processes at Step S252 and subsequent steps have been performed for all light sources remaining as the candidates for vehicle light (Yes at Step S255), the control unit 15 identifies a group of light sources that currently remain as the candidates for vehicle light as vehicle lights (Step S259). The control unit 15 then ends the flashing light source elimination process. However, when no light source remains as a candidate for vehicle light at Step S259, the control unit 15 determines that no vehicle light is present in the area ahead of the own vehicle and ends the flashing light source elimination process.

In addition, when the vehicle light is identified by the flashing light source elimination process at Step S250, the control unit 15 proceeds to S260. The control unit 15 transmits (outputs), to the vehicle control apparatus 20 over the in-vehicle LAN, information indicating the detection results of the vehicle light including whether or not a vehicle light is present in the area ahead of the own vehicle, as the information indicating the state ahead of the vehicle. The information indicating the detection results of the vehicle light can include information indicating the number of vehicle lights in the area ahead of the own vehicle, distance/direction to the vehicle light, and the like in addition to the information indicating whether or not the vehicle light is present. The control unit 15 then ends the flashing light source elimination process.

Details of the process performed by the control unit 15 at night when the function of the auto high-beam system is turned ON is described above. However, in other environments, for example, the control unit 15 may be configured to perform only the stereoscopic detection process, among the stereoscopic detection process and the vehicle light detection process.

In addition, the vehicle control apparatus 20 performs vehicle control based on the information related to the distance to an object present in the area ahead of the own vehicle and the information indicating the detection results of the vehicle light in the area ahead of the own vehicle serving as the information indicating the state ahead of the vehicle, transmitted from the image analysis apparatus 10. Specifically, at night when the function as the auto high-beam system is turned ON, the vehicle control apparatus 20 controls the headlights 3 based on the information indicating the detection results of the vehicle light received from the image analysis apparatus 10 and adjusts the irradiation angles of the beams from the headlights 3. For example, at night when the function as the auto high-beam system is turned ON and the headlights 3 are lit, the vehicle control apparatus 20 repeatedly performs a headlight automatic control process shown in FIG. 8.

According to the headlight automatic control process, when the information indicating the detection results of the vehicle light received from the image analysis apparatus 10 is information indicating that the vehicle light is present (Yes at Step S310), the vehicle control apparatus 20 switches the irradiation angle in the up/down direction of the beams from the headlights 3 to low. In other words, the vehicle control apparatus 20 controls the headlights 3 so that so-called low beams are outputted from the headlights 3 (Step S320). On the other hand, when the information indicating the detection results of the vehicle light received from the image analysis apparatus 10 is information indicating that the vehicle light is not present (No at Step S310), the vehicle control apparatus 20 switches the irradiation angle of the beams from the headlights 3 to high (Step 330). In other words, the vehicle control apparatus 20 controls the headlights 3 so that so-called high beams are outputted from the headlights (Step S330). The vehicle control apparatus 20 repeatedly performs such processes. In addition, when the information indicating the detection results of the vehicle light cannot be received from the image analysis apparatus 10 for a certain period or longer, the vehicle control apparatus 20 can control the headlights 3 so that low beams are outputted from the headlights 3.

A configuration of the vehicle control system 1 of the present example is described above. In the present example, through control of the left camera 11L and the right camera 11R, images of the area ahead of the own vehicle common to both the left camera 11L and the right camera 11R are captured. Pieces of image data (left image data and right image data) expressing the captured images are generated. At this time, the exposure timings of the left camera 11L and the right camera 11R are controlled so that the exposure timing of the left camera 11L is shifted from that of the right camera 11R. Pieces of image data (left image data and right image data) that differ in exposure timings are obtained from the left camera 11L and the right camera 11R. Then, based on either the left image data or the right image data (left image data in the above-described example), the candidates for vehicle light are extracted (Step S230).

Furthermore, as a result of comparison between the left image data and the right image data that differ in exposure timings, light that appears in the left image data and periodically flashes is detected (Steps S251 to S253). Specifically, regarding each light source serving as a candidate for vehicle light extracted at Step S230, the difference between the luminance in the left image data and the luminance in the right image data of the light source is calculated (Step S252). Each light of which the calculated difference in luminance is greater than a reference value is detected as a flashing light (Step S253).

The flashing light is then eliminated from the candidates for vehicle light extracted at Step S230 (Step S254). The light sources that ultimately remain as the candidates for vehicle light are detected as the vehicle light (Step S259).

In other words, in the present example, the flashing lights are detected based on a pair of image data having differences in exposure timing. As a result, a high-frequency flashing light source, such as an LED traffic signal, can be detected using a typical stereo camera 11 as the camera 11L and the camera 11R, without use of a camera capable of high-speed sampling or the like. Flashing light sources that are not vehicle lights can be eliminated and the vehicle light can be accurately detected. Therefore, in the present example, the image analysis apparatus 10 capable of detecting vehicle light with high accuracy can be manufactured at low cost.

In addition, in the present example, detection of vehicle light can be performed with high accuracy using the stereo camera 11 for distance detection. Therefore, a high-performance vehicle control system 1 can be efficiently constructed.

In other words, according to the present example, as a result of the stereo imaging mode, the left camera 11L and the right camera 11R are controlled so that the exposure timings of the left camera 11L and the right camera 11R match. Stereo image data (left image data and right image data) that is composed of the pair of image data generated by the left camera 11L and the right camera 11R as a result of the exposure is acquired. Based on the stereo image data, the distance to each object in the area ahead of the own vehicle including vehicle lights is detected (Step S130). The distance is used for vehicle control. In addition, the detection accuracy of vehicle light is enhanced by use of the detection results for distance. Therefore, vehicle control based on the results of stereoscopic viewing of the area ahead of the own vehicle and vehicle control (headlight 3 control) based on the detection results of for vehicle light can be efficiently actualized with high accuracy using a single stereo camera 11.

However, the present invention is not limited to the above-described example. It goes without saying that various embodiments can be used. For example, in the above-described example, the detection results for the distance to an object in the area ahead of the own vehicle obtained by the stereoscopic detection process is used in the vehicle light detection process (Step S240). The candidates for vehicle light are thereby culled. However, the detection results for distance by the stereoscopic detection process are not necessarily required to be used for detection of vehicle lights. In other words, the control unit 15 may be configured so as not to perform the process at Step S240.

In addition, the details of the process for extracting the candidates for vehicle light at Step S230 is not limited to the above-described example. Various known technologies may be applied to the process at Step S230. In addition, the control unit 15 can be configured as a dedicated integrated circuit (IC).

Finally, correlations will be described. The image analysis apparatus 10 in the above-described example corresponds to an example of a light detection apparatus. The right camera 11R and the left camera 11L correspond to examples of first and second imaging means.

In addition, the function actualized by Steps S110, S120, S210, and S220 performed by the control unit 15 corresponds to an example of a function actualized by a control means. The function actualized by Steps S130, S230 to S250, and S251 to S259 performed by the control unit 15 corresponds to an example of a function actualized by a vehicle light detecting means.

In addition, the function actualized by Step S230 performed by the control unit 15 corresponds to an example of a function actualized by a candidate detecting means. The function actualized by Steps S251 to S253 corresponds to an example of a function actualized by a flashing light detecting means. The function actualized by Step S254 corresponds to an example of a function actualized by an eliminating means. In addition, the function actualized by the process at Step S130 performed by the control unit 15 corresponds to an example of a function for detecting the distance to light actualized by the vehicle light detecting means.

In addition, the function actualized by the headlight automatic control process performed by the vehicle control apparatus 20 corresponds to an example of a function actualized by a headlight control means.

### REFERENCE SIGNS LIST

1 vehicle control system
3 headlights
10 image analysis apparatus
11 stereo camera
11R right camera
11L left camera
15 control unit
15A CPU
15B memory
20 vehicle control apparatus

What is claimed is:

1. A light detection apparatus that detects light from a vehicle, comprising:
first and second imaging means for capturing images of a common area ahead and generating pieces of image data expressing the captured images;
a control means for controlling exposure timings of the first and second imaging means so that the exposure timing of the second imaging means is shifted from that of the first imaging means, and acquiring a pair of image data having differing exposure timings from the first and second imaging means; and
a vehicle light detecting means for analyzing the pieces of image data obtained from the first and second imaging means by operation of the control means, and detecting vehicle light that is captured in the pieces of image data, wherein
the vehicle light detecting means includes
a flashing light detecting means for detecting light that is captured in the pieces of image data and is flashing by comparing the image data obtained from the first imaging means and the image data obtained from the second imaging means, and
an eliminating means for eliminating light detected by the flashing light detecting means from candidates for vehicle light.

2. The light detection apparatus according to claim 1, wherein:
the vehicle light detecting means further includes
a candidate detecting means for detecting light serving as a candidate for vehicle light captured in the image data, based on either of the pieces of image data obtained from the first and second imaging means by operation of the control means, and
the eliminating means eliminates the light that is flashing, detected by the flashing light detecting means, from the lights detected as the candidates for vehicle light by the candidate detecting means.

3. The light detection apparatus according to claim 2, wherein:
the flashing light detecting means calculates, for each light serving as the candidate for vehicle light detected by the candidate detecting means, a difference between the luminance in the image data obtained from the first imaging means and the luminance in the image data obtained from the second imaging means of the light, and detecting each light of which the calculated difference in luminance is greater than a reference as the light that is flashing.

4. The light detection apparatus according to claim 3, wherein:
the control means includes, in addition to a first operating mode in which the exposure timings of the first and second imaging means are controlled so that the exposure timing of the second imaging means is shifted from that of the first imaging means and the pair of image data having differing exposure timings is obtained from the first and second imaging means, a second operating mode in which the exposure timings of the first and second imaging means are controlled so as to match and a stereo image data composed of a pair of image data generated by the first and second imaging means by the exposure is obtained, and
the vehicle light detecting means has a function for detecting the distance to light captured by the first and second imaging means based on the stereo image data obtained in the second operating mode.

5. The light detection apparatus according to claim 2, wherein:
the control means includes, in addition to a first operating mode in which the exposure timings of the first and second imaging means are controlled so that the exposure timing of the second imaging means is shifted from that of the first imaging means and the pair of image data having differing exposure timings is obtained from the first and second imaging means, a second operating mode in which the exposure timings of the first and second imaging means are controlled so as to match and a stereo image data composed of a pair of image data generated by the first and second imaging means by the exposure is obtained, and
the vehicle light detecting means has a function for detecting the distance to light captured by the first and second imaging means based on the stereo image data obtained in the second operating mode.

6. The light detection apparatus according to claim 1, wherein:
the control means includes, in addition to a first operating mode in which the exposure timings of the first and second imaging means are controlled so that the exposure timing of the second imaging means is shifted from that of the first imaging means and the pair of image data having differing exposure timings is obtained from the first and second imaging means, a second operating mode in which the exposure timings of the first and second imaging means are controlled so as to match and a stereo image data composed of a pair of image data generated by the first and second imaging means by the exposure is obtained, and
the vehicle light detecting means has a function for detecting the distance to light captured by the first and second imaging means based on the stereo image data obtained in the second operating mode.

7. A vehicle control system comprising:
the light detection apparatus according to claim 1; and
a headlight control means for switching an irradiation direction of beams from headlights of an own vehicle, based on the detection results for vehicle light from the light detection apparatus.

8. A detection method for light from a vehicle in an apparatus that detects the light from a vehicle, the apparatus including first and second imaging means for capturing images of a common area ahead and generating pieces of image data expressing the captured images, and a control means for controlling exposure timings of the first and second imaging means so that the exposure timing of the second imaging means is shifted from that of the first imaging means, and acquiring a pair of image data having differing exposure timings from the first and second imaging means, the detection method comprising:
an analyzing step of analyzing the pieces of image data obtained from the first and second imaging means by operation of the control means; and
a detecting step of detecting vehicle light captured in the pieces of image data from the analysis results, wherein
the analyzing step includes a process for detecting light that is captured in the pieces of image data and is flashing by comparing the image data obtained from the first imaging means and the image data obtained from the second imaging means, and
the detecting step includes a process for eliminating the light that is flashing from candidates for vehicle light.
